(19) United States
(12) Patent Application Publication
(10) Pub. No.: US 2018/0007722 A1
(43) Pub. Date: Jan. 4, 2018

(54) Unauthorized Users Notification

(71) Applicants: Daniel Cohn, Raanana (IL); Elad Levy, Nes Ziona (IL); Michael Glik, Kfar Saba (IL); Solomon Trainin, Haifa (IL); Tal Davidson, Petach Tikva (IL)

(72) Inventors: Daniel Cohn, Raanana (IL); Elad Levy, Nes Ziona (IL); Michael Glik, Kfar Saba (IL); Solomon Trainin, Haifa (IL); Tal Davidson, Petach Tikva (IL)

(21) Appl. No.: 15/200,343

(22) Filed: Jul. 1, 2016

(51) Int. Cl. H04W 76/02; H04L 29/08; H04W 48/02; H04W 68/00

(52) U.S. Cl. CPC H04W 76/023; H04W 68/005; H04L 67/1044; H04W 48/02

(57) ABSTRACT

This disclosure describes systems, methods, and devices related to unauthorized users notification. A device may identify a request from a first device to establish a direct connection. The device may determine a connection status based at least in part on information included in the request. The device may generate a response frame including a connection status information element (IE). The device may cause to send the response frame to the first device.

### TECHNICAL FIELD

This disclosure generally relates to systems, methods, and devices for wireless communications and, more particularly, to unauthorized users notification.

### BACKGROUND

Computing devices having wireless capabilities may communicatively couple to other devices having wireless capabilities via a wireless local area network (WLAN) using wireless technologies such as Wi-Fi. Also, wireless technologies, such as WiGig, ultra-wide band (UWB), Wireless USB™ or WirelessHD, may allow wirelessly capable devices to replace wired interconnects with high speed and relatively short range wireless interconnects via a process typically referred to as wireless docking. The high speed and relatively short range wireless interconnects may allow devices to wirelessly dock with each other. One device may be a computing device such as a laptop or a notebook, and the other may be a type of input/output device such as a monitor or a printer. In some examples, once wirelessly docked, the computing devices may utilize the input/output device in a same manner as if connected to the input/output device via a wired interconnect (e.g., routed through a physical docking station).

### BRIEF DESCRIPTION OF THE DRAWINGS

FIG. 1 depicts a network diagram illustrating an example network environment of an unauthorized users notification system, in accordance with one or more example embodiments of the present disclosure.

FIG. 2 depicts an illustrative schematic diagram of an unauthorized users notification system, in accordance with one or more example embodiments of the present disclosure.

FIG. 3 depicts an illustrative schematic diagram of an unauthorized users notification system, in accordance with one or more example embodiments of the present disclosure.

FIG. 4A depicts a flow diagram of an illustrative process for an unauthorized users notification system, in accordance with one or more example embodiments of the present disclosure.

FIG. 4B depicts a flow diagram of an illustrative process for an unauthorized users notification system, in accordance with one or more example embodiments of the present disclosure.

FIG. 5 illustrates a functional diagram of an example communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Examples are generally directed to improvements for wirelessly capable devices to wirelessly couple using wireless technologies such as Wi-Fi, WiGig, UWB, Wireless USB™ or WirelessHD. These wireless technologies may include establishing and/or maintaining wireless communication links through various frequency bands such as those used for Wi-Fi and/or WiGig, e.g., 2.4, 5 or 60 GHz. These wireless technologies may also include wireless technologies suitable for use with devices capable of coupling to other devices via a WLAN or via a peer-to-peer (P2P) wireless connection. For example, these devices may be configured to operate in compliance with various standards or specifications promulgated by the Institute of Electrical and Electronic Engineers (IEEE) or the Wi-Fi Alliance. These standards or specifications may include Ethernet wireless standards (including progenies and variants) associated with the IEEE Standard for Information technology. These standards or specifications may also include the Wi-Fi Peer-to-Peer (P2P) Technical Specification.

In some examples, standards or specifications such as Wi-Fi, WiGig, UWB, Wireless USB™, WirelessHD, Wi-Fi P2P, or various IEEE standards such as IEEE 802.11a/g, IEEE 802.11ac, IEEE 802.11ad or IEEE 802.11i may be utilized by devices to establish or maintain a WLAN and/or a P2P communication link and/or to establish wireless communications with each other (e.g., wireless docking). The devices may include one or more input and output devices for sharing information with other devices upon wirelessly docking with the other devices. For example, Wi-Fi P2P enables Wi-Fi devices to connect directly to each other, making it simple and convenient to do things like print, share, sync and display.

There are several network applications where the owner of a network resource may wish to restrict access to the network resource to a certain subset of users. One example may be when a wireless device attempts to wirelessly dock with another wireless device. The wireless device may be connected to a storage device containing sensitive information that the wireless device does not permit other devices to access. In some scenarios, if an unauthorized user attempts to connect to a restricted resource, the conditions or circumstances for which the unauthorized user was denied access may not be available to the unauthorized user.

Example embodiments of the present disclosure relate to systems, methods, and devices for an unauthorized users notification device. For example, when an unauthorized user attempts to connect to a restricted resource, it may be desirable to communicate the reason for the connection rejection, including information that may help the user understand the reason and possibly provide a resolution.

Even in existing password-based authentication mechanisms (e.g. WPA personal—not supported in P2P), the standard method to restrict access to specific users is to define a password that is not known to these users. When this method is used, unauthorized users do not get any information about the reason why they cannot connect or how to remedy this situation. Also, a device finds out it cannot connect only after a connection attempt (which requires user intervention), so no information on the restriction can be displayed on a user interface.

In one embodiment, the unauthorized users notification system may facilitate defining a mechanism for rejecting and notifying unauthorized users about the reason for the rejection and a possible resolution.

In one embodiment, the unauthorized users notification system may define an information element (IE) that may include one or more status codes associated with the unauthorized connection. For example, the unauthorized users notification system may define a status code to indicate an access or connection restriction. The status code may be utilized to signal to an unauthorized user that access to a request resource is restricted.

In one embodiment, the unauthorized users notification system may use the new code and the new IE during negotiation messaging between two devices. Using P2P as an example, the unauthorized users notification system may utilize P2P invitation response, provision discovery response and group owner (GO) negotiation response frames to include the status code and the new IE to signal to an unauthorized user a connection rejection. These frames may include additional information to assist the user in acquiring access to another device. For example, the IE may include contact information fields to assist the unauthorized user in contacting the owner of the restricted device to request authorization.

In one embodiment, the unauthorized users notification system may include an IE in the probe response message to determine whether a device is authorized to connect to another device. For example, the IE may be defined as a “restricted device attribute” IE that may be included in a probe response message. This may allow a device to query a peer device on whether the device is authorized to connect to it, and to display this information in the device's graphical user interface (GUI).

Existing P2P solutions do not provide any known mechanism to restrict user access to a certain resource. The supported pairing mechanisms, such as a personal identification number (PIN) or a push-button configuration (PBC), cannot be used to restrict specific clients from connecting. A PIN mechanism utilizes a unique PIN that will be required for each device to join the network. However, this mechanism does not restrict devices from some resources but not others. In a PBC mechanism, a user may connect multiple devices to the network and enable data encryption by pushing a button. Specifically, an access point (AP) will have a physical button, and other devices may have a physical or software-based button so that pushing the button allows devices to join the network within a predetermined time from pushing the button. Again this mechanism does not restrict devices from specific resources on the network.

In one embodiment, the unauthorized users notification system may facilitate early signaling of access restriction resulting in power conservation during the discovery phase. That is, the unauthorized users notification system may allow a device to determine whether it is authorized to connect to another device even before the device attempts to connect. Information may be displayed to the user at the device GUI. The information may be a grayed out list of restricted devices, in case the device is unauthorized to access these restricted devices. In another embodiment, the information may not be even presented to the unauthorized device.

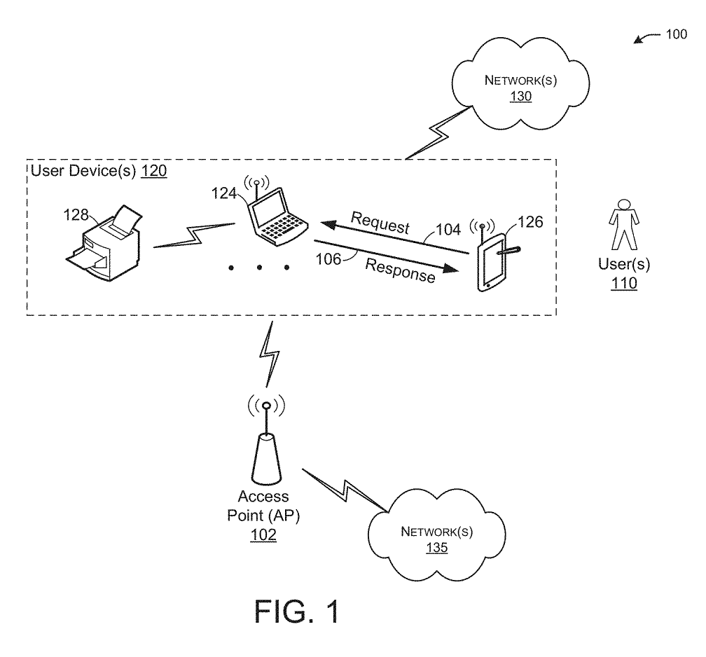

FIG. 1 is a network diagram illustrating an example network environment of an unauthorized users notification system, in accordance with one or more example embodiments of the present disclosure. Wireless network 100 may include one or more user devices 120 and one or more access point(s) (AP) 102, which may communicate in accordance with communication standards such as Wi-Fi, WiGig, UWB, Wireless USB™, WirelessHD, Wi-Fi P2P, or various IEEE standards such as IEEE 802.11a/g, IEEE 802.11ac, IEEE 802.11ad or IEEE 802.11i. The user device(s) 120 may be mobile devices that are non-stationary (e.g., not having fixed locations) or may be stationary devices.

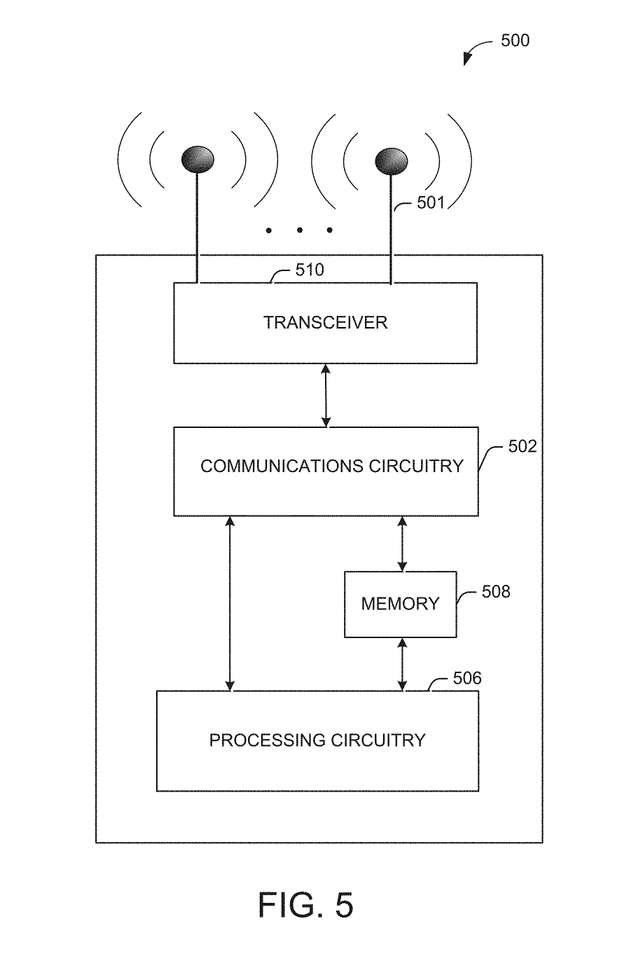

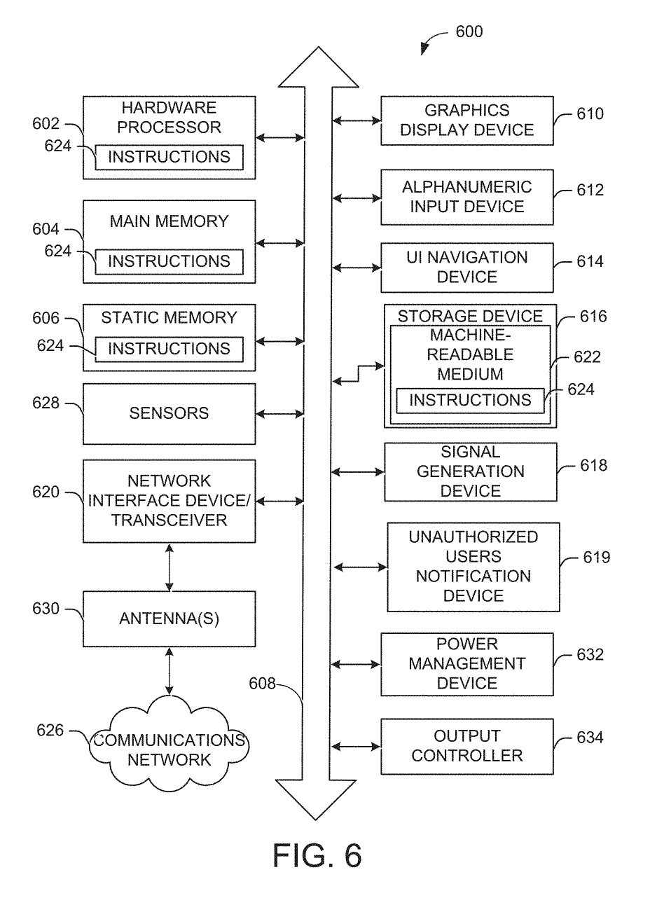

In some embodiments, the user devices 120 and the AP 102 may include one or more computer systems similar to that of the functional diagram of FIG. 5 and/or the example machine/system of FIG. 6.

One or more illustrative user device(s) 120 and/or AP 102 may be operable by one or more user(s) 110. The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

Any of the user device(s) 120 (e.g., user devices 124, 126, 128), and AP 102 may be configured to communicate with each other via one or more communications networks 130 and/or 135 wirelessly or wired. The user device(s) 120 may also communicate peer-to-peer or directly with each other with or without the AP 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Wi-Fi Direct devices, formally known as P2P devices, communicate by establishing P2P groups, which are functionally equivalent to traditional Wi-Fi infrastructure networks. The device implementing AP-like functionality in the P2P group is referred to as the P2P group owner (P2P GO), and devices acting as clients are known as the P2P clients. In order to establish a communication, the P2P devices have to agree on the role that each device will assume at the time of negotiation. Once the two P2P devices have found each other, they start the GO negotiation phase. This phase is implemented using a three-way handshake, namely GO negotiation, where the two devices agree on which device will act as the P2P GO and on which channel the group will operate. Once the P2P group is established, other P2P devices can join the group as in a traditional Wi-Fi network. Legacy clients can also communicate with the P2P GO, as long as they support the required security mechanisms.

In one embodiment, and with reference to FIG. 1, one or more user devices 120 may communicate directly with each other, with or without the AP 102. For example, user device 126 may attempt to wirelessly dock with user device 124 in order to gain access to user device 128 that may be associated with user device 124. User devices 124 and 126 may communicate with each other in order to determine whether establish a connection between them. In this example, the user device 126 may send a request 104 to determine various information such as the capability of the user device 124 and/or the user device 128 and other connection-related information. The user device 124 may respond with a response message 106 that provides necessary information for the possible connection. However, in certain scenarios, the user device 124 may choose that the user device 128 will be restricted. In that case, the user device 126 may not be authorized to access the user device 128.

In one embodiment, the conditions or circumstances for which the unauthorized user was denied access may be provided to the requesting device.

In one embodiment, the user device 124 may respond to the user device 126 with information such as a rejection mechanism in addition to a notification containing the reason for the rejection and possibly providing a resolution.

In another embodiment, the user device 124 may provide early signaling of access restriction during the discovery phase with the user device 126. That is, the user device 126 may determine whether it is authorized to connect to the user device 124 even before the user device 126 attempts to connect to the user device 124. For example, the information may be displayed to the user at the device GUI. For example, if the user device 126 is unauthorized to access the user device 128, when the user device 126 is in the scanning stage looking for devices in its proximity that may be available for connectivity purposes, the user device 128 may be visible to the user device 126. However, the user device 128 may be presented to the user device 126 as a grayed out device so that the user device 126 is unable to connect to or select the user device 128. In other embodiments, during the scanning stage, the user device 126 may be unable to even see the user device 128 as an option for connectivity purposes. This may provide a power consumption benefit so that the user device 126 does not need to attempt to connect to or access the user device 128. Instead, the user device 126 is able to determine that it is unauthorized to access the user device 128.

In one embodiment, the user device 126 may perform scanning by sending probe requests in each channel in order to receive probe responses from other devices. Once two devices have found each other, the GO negotiation phase takes place. However, in case a probe request is received by the user device 124 from the user device 126, the user device 124 may identify or otherwise extract information from the probe request. The information may include at least in part device capabilities, a device ID, an internet protocol (IP) address, a user name (e.g., a user name associated with the user device 126), a device location, or other identifying or requested information. Based on at least some of the identified or extracted information, the user device 124 may respond with a probe response so that the user device 124 is able to provide the user device 126 with additional information associated with devices that may be accessible or not accessible by the user device 126. For example, based on a device ID, the user device 124 may set a connection status for the user device 126. The user device 124 may then send a probe response that may include, at least in part, the connection status. For example, in the probe response, the user device 124 may provide additional information that may assist the user device 126 in determining whether it is authorized to access one or more devices associated with the P2P group. In the example of FIG. 1, the user device 126 may determine based on receiving the probe response that the user device 128 is unavailable because the user device 128 may be grayed out. In another example, the user device 128 may not even be visible to the user device 126.

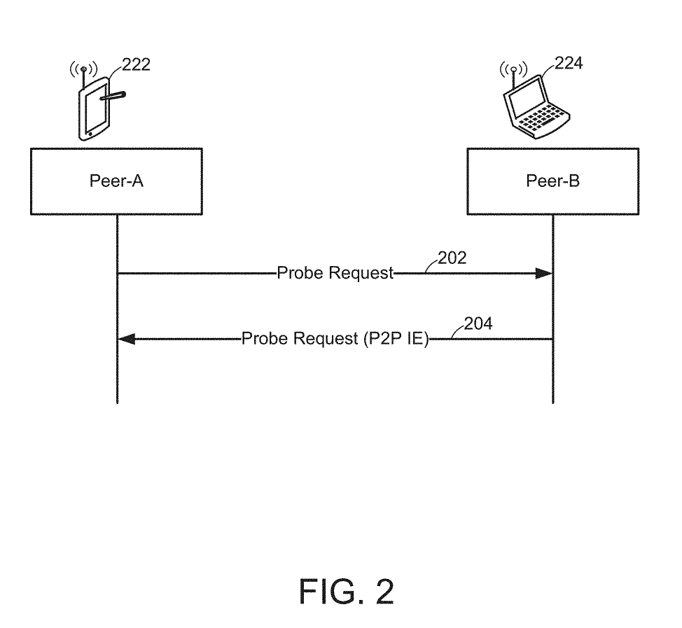

FIG. 2 depicts an illustrative schematic diagram of an unauthorized users notification system, in accordance with one or more example embodiments of the present disclosure.

Referring to FIG. 2, there is shown two user devices 222 and 224. These user devices may be involved in a communication such that user device 222 wishes to wirelessly dock with user device 224. In this example, one or more messages may be exchanged between the user devices 222 and 224, such that the wireless dock may be established. However, in certain scenarios, the user device 222 may not be authorized to wirelessly dock with user device 224.

In the example of FIG. 2, when the two devices (e.g., user devices 222 and 224) wish to establish a P2P connection with each other, the two devices may perform a P2P discovery procedure. The objective of P2P discovery procedure is to find P2P devices and determine the P2P device to which a connection will be attempted. A P2P discovery procedure may include one or more stages such as a scan phase and a find phase. In the scan phase, all supported channels are scanned by a P2P device in order to find other P2P devices. In the find phase, a P2P device may use a listen state or search state in order to become discoverable. The find phase is used to ensure that two simultaneously searching P2P devices arrive on a common channel to enable communication.

In one embodiment, an unauthorized users notification system may facilitate the use of a probe request message, a probe response message, and the addition of a new P2P attribute to the probe response message. Probes are types of management frames that may include a probe request and a probe response message. A probe request may be a message requesting information from the device that receives the probe request. In the example of FIG. 2, the user device 222 may send a probe request 202 to the user device 224 in order to request information from the user device 224. Information requested may be included in a P2P IE 204, which may include, at least in part, P2P capabilities, a P2P device ID, a listen channel, an operating channel, etc. The probe response message may include a response to the requested information.

In one embodiment, the unauthorized users notification system may facilitate notification by a device with access restrictions for unauthorized devices. For example, the notification may be included in a probe response message sent from the device to the unauthorized device attempting to gain access (e.g., to wirelessly dock) to the device. In that case, the probe response may include an additional attribute to the P2P IE that may include the notification. The attribute may be associated with the restrictions that may be applied to the device. In one example, the new P2P attribute may be defined as a “restricted device attribute” that may be included in the P2P IE of a probe response message sent by the device having the restricted access.

In one embodiment, the restricted device attribute may be comprised of one or more fields. Referring to Table 1 below, a restricted device attribute may include an attribute ID, a length field, and an owner device name field. The attribute ID may identify the restricted device attribute in the probe response, the length field may identify the length of associated fields, and the owner device name field may identify the user or P2P device that placed the restriction.

TABLE 1

| | Size | | |
|---|---|---|---|
| Field | (octets) | Value | Description |
| Attribute | 1 | TBD | Identifying the “restricted device” P2P |
| ID | | | attribute |
| Length | 2 | 1 | Length of the following fields |
| | | | in the attribute |
| Owner | Variable | | Friendly name identifying the User or P2P |
| device | | | device that originally placed the restriction |
| name | | | on the sending device (in the example |
| | | | above-Peer-B) |

In one embodiment, the unauthorized users notification system may reject P2P connection attempts from unauthorized devices. For example, if the user device 222 is not permitted to connect to the user device 224, the user device 224 may choose not to present itself as an available resource in its discovery results. In some scenarios, the user device 224 may present itself to the user device 222 as a peer device that is unavailable for connection and may provide the user device 222 with the owner information mentioned above. It is understood that the above descriptions are for purposes of illustration and are not meant to be limiting.

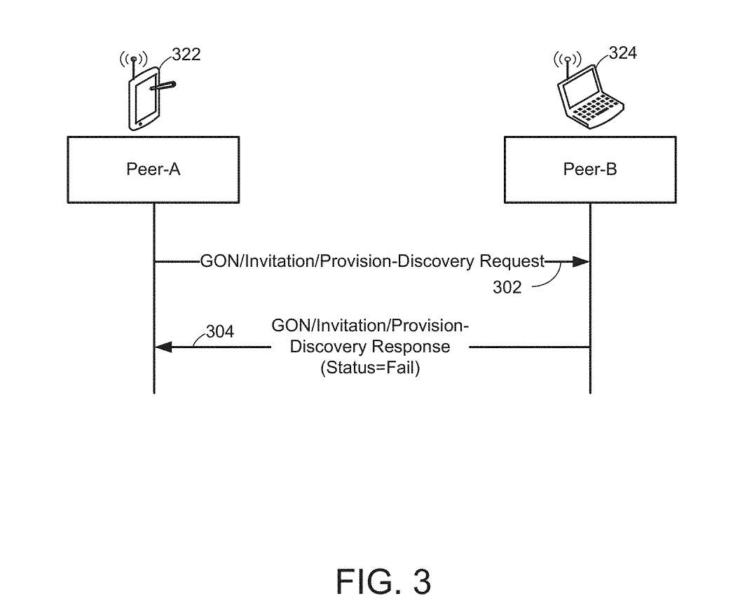

FIG. 3 depicts an illustrative schematic diagram of an unauthorized users notification system, in accordance with one or more example embodiments of the present disclosure.

In some embodiments, other types of messaging (e.g., P2P public action frames) may be used in order to provide a device with a rejection indication. When a P2P device finds another P2P device, the P2P devices may transition to the group owner negotiation (GON) and provisioning phase. For example, in a scenario where two devices such as user devices 322 and 324 are available for a P2P type of communication, there may be various types of messaging that may be exchanged between these devices when attempting to connect to each other. Some of these messages may include a GON request, an invitation request, a provision discovery request, etc. It should be understood that the GON request is a P2P public action frame request that may be transmitted by a P2P device to another P2P device to initiate a P2P connection. The invitation request may be transmitted by a P2P device that is a member of a P2P group to another P2P device not currently a member of the P2P group to invite that P2P device to join the P2P group. The provision discovery request may be used by a P2P device that desires to join an existing P2P group. It should be understood that although the GON request, the invitation request, and the provision discovery request are used, other types of messages may be used to include one or more indications of an unauthorized users notification.

Referring to FIG. 3, the user device 322 may send a request 302 (e.g., GON, invitation, provision discovery request) to the user device 324 in order to attempt to connect (e.g., wirelessly dock). In case the user device 322 is unauthorized to connect to the user device 324 or other devices associated with the user device 324, the user device 324 may respond to the request 302 with a response 304 (e.g., GON, invitation, provision discovery response). The response 304 may include at least in part a new P2P status code that may indicate a failed status. For example, the new P2P status code may be “fail; station not authorized to connect.” Additionally, the response 304 may include a P2P IE that may include the failure notification. For example, the P2P IE may use the restricted device attribute outlined in Table 1, so that the user device 322 is able to determine, based on the information included in the response 304, a reason for the connection failure, in addition to other useful information such as the owner or possible ways to resolve the connection failure. It is understood that the above descriptions are for purposes of illustration and are not meant to be limiting.

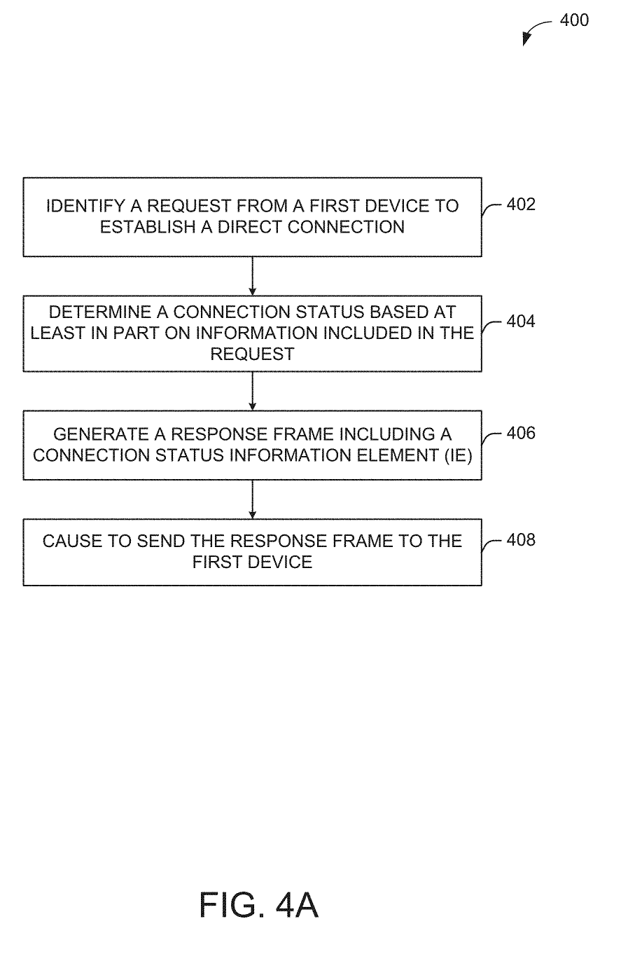

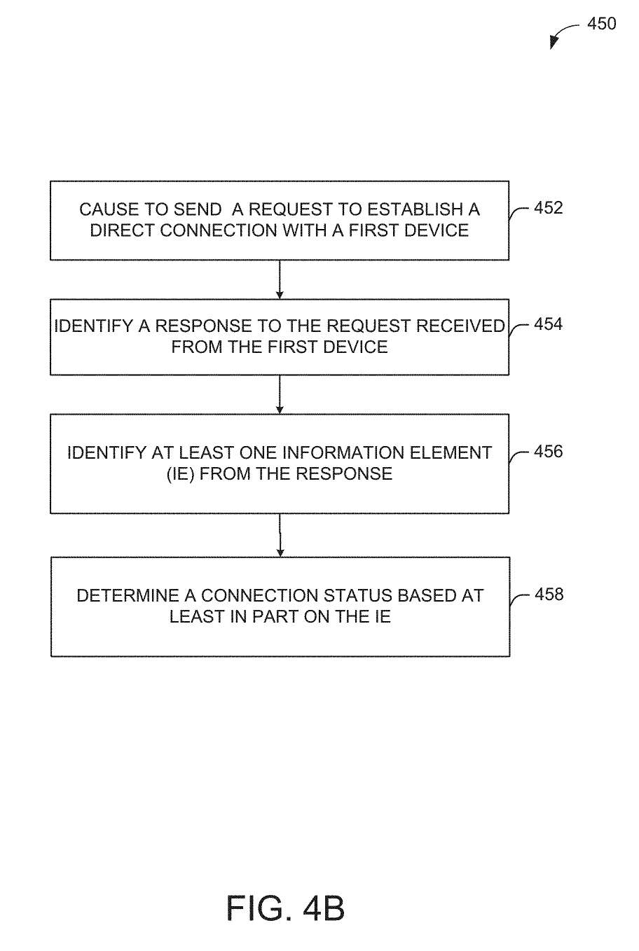

FIG. 4A illustrates a flow diagram of an illustrative process 400 for an unauthorized users notification system, in accordance with one or more example embodiments of the present disclosure.

At block 402, a device (e.g., the user device(s) 120 and/or the AP 102 of FIG. 1) may identify a request from another device (e.g., the user device(s) 120 and/or the AP 102 of FIG. 1) to establish a direct connection. The devices may include one or more input and output devices for sharing information with other devices upon wirelessly docking with the other devices. For example, Wi-Fi P2P enables Wi-Fi devices to connect directly to each other, making it simple and convenient to do things like print, share, sync and display. The request is at least one of a probe request, a group owner negotiation (GON) request, an invitation request, or a provision discovery request. The device may identify or otherwise extract information from the request. The information may include at least in part device capabilities, a device ID, an internet protocol (IP) address, a user name, a device location, or other identifying or requested information. The device may determine the connection status based at least in part on the identified or extracted information.

At block 404, the device may determine a connection status based at least in part on information included in the request. Based on at least some of the identified or extracted information, the device receiving the request may respond with a probe response so that the device receiving the request is able to provide the device sending the request with additional information associated with devices that may be accessible or not accessible by the device sending the request. For example, when an unauthorized user attempts to connect to a restricted resource, it may be desirable to communicate the reason for the connection rejection, including information that may help the user understand the reason and possibly provide a resolution. For example, an information element (IE) may include one or more status codes associated with the unauthorized connection to indicate a connection status. For example, the connection status code may be determined to indicate an access or connection restriction. The connection status code may be utilized to signal to an unauthorized user that access to a request resource is restricted. If for example the request is a probe request, the probe request may be a message requesting information from the device that receives the probe request. For example, the requested information may be included in a P2P IE, which may include, at least in part, P2P capabilities, a P2P device ID, a listen channel, an operating channel, etc. The probe response message may include a response to the requested information.

At block 406, the device may generate a response frame including a connection status information element (IE). For example, a new P2P attribute may be added to the probe response. The attribute may be associated with the restrictions that may be applied to the device. The new P2P attribute may be defined as a “restricted device attribute” that may be included in the P2P IE of a probe response message sent by the device having the restricted access. The connection status code may be called “Fail; station not authorized to connect” to signal the access restriction, and a new IE called “restricted device attribute” provides more detailed information about reason for the new status response.

At block 408, the device may cause to send the response frame to the other device. For example, if the connection attempt is made by an unauthorized device, the response frame may include the connection status code, which may indicate to the unauthorized device that the connection attempt failed. Further, the response frame may include additional information such as the owner of the device that has been restricted. This information may assist the unauthorized device in resolving the connection failure. In other examples, the unauthorized device may be able to determine that it is unauthorized to access a certain device during a discovery stage so that the unauthorized user is either prevented from seeing devices that might be restricted to that unauthorized device, or devices may be grayed out so that the unauthorized device is unable to select them.

FIG. 4B illustrates a flow diagram of an illustrative process 450 for an unauthorized users notification system, in accordance with one or more example embodiments of the present disclosure.

At block 452, a device (e.g., the user device(s) 120 and/or the AP 102 of FIG. 1) may cause to send a request to establish a direct connection with another device (e.g., the user device(s) 120 and/or the AP 102 of FIG. 1). The devices may include one or more input and output devices for sharing information with other devices upon wirelessly docking with the other devices. For example, Wi-Fi P2P enables Wi-Fi devices to connect directly to each other, making it simple and convenient to do things like print, share, sync and display. The request is at least one of a probe request, a group owner negotiation (GON) request, an invitation request, or a provision discovery request. The device may encode or otherwise add information to the request. The information may include at least in part device capabilities, a device ID, an internet protocol (IP) address, a user name, a device location, or other identifying or requested information.

At block 454, the device may identify a response to the request sent from the first device. Using P2P as an example, a probe response, a P2P invitation response, a provision discovery response or a GO negotiation response may be used.

At block 456, the device may identify or otherwise extract at least one information element (IE) from the response. These responses may include a status code and a new IE to signal to an unauthorized device a connection rejection. These responses may include additional information to assist the user in acquiring access to another device. For example, the IE may include contact information fields to assist the user in contacting the owner of the restricted device to request authorization.

At block 458, the device may determine a connection status based at least in part on the IE. The device may determine a connection status based at least in part on information included in the request. Based on at least some of the information sent in the request, the device receiving the request may respond with a probe response so that the device receiving the request is able to provide the device sending the request with additional information associated with devices that may be accessible or not accessible by the device sending the request. For example, an information element (IE) may include one or more status codes associated with the unauthorized connection to indicate a connection status. For example, the connection status code may be determined to indicate an access or connection restriction. The connection status code may be utilized to signal to an unauthorized user that access to a request resource is restricted. If for example the request is a probe request, the probe request may be a message requesting information from the device that receives the probe request. For example, the requested information may be included in a P2P IE, which may include, at least in part, P2P capabilities, a P2P device ID, a listen channel, an operating channel, etc. The probe response message may include a response to the requested information. In addition to that, the probe response may include the IE that includes the one or more status codes associated with an unauthorized connection. This response provides the requesting device with additional information in case it is not authorized to connect. The IE may include information such as an attribute ID, a length field, and an owner device name field. For example, the owner device name field may identify the user or P2P device that placed the restriction. In some examples, early signaling of the access restriction may be achieved during the discovery phase between the two devices. That is, the unauthorized users notification system may allow a device to determine whether it is authorized to connect to another device even before the device attempts to connect. Information may be displayed to the user at the device GUI. The information may be a grayed out list of devices, in case the device is unauthorized to access these devices. In another embodiment, the information may not be even presented to the unauthorized device.

FIG. 5 shows a functional diagram of an exemplary communication station 500 in accordance with some embodiments. In one embodiment, FIG. 5 illustrates a functional block diagram of a communication station that may be suitable for use as an AP 102 (FIG. 1) or user device 120 (FIG. 1) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or media access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in FIGS. 1, 2, 3, 4A and 4B.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device memory.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an unauthorized users notification device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The unauthorized users notification device 619 may carry out or perform any of the operations and processes (e.g., the processes 400 and 450) described and shown above. For example, the unauthorized users notification device 619 may be configured to facilitate defining a mechanism for rejecting and notifying unauthorized users about the reason for the rejection and a possible resolution.

The unauthorized users notification device 619 may define an information element (IE) that may include one or more status codes associated with the unauthorized connection. For example, the unauthorized users notification system may define a status code to indicate an access or connection restriction. The status code may be utilized to signal to an unauthorized user that access to a request resource is restricted.

The unauthorized users notification device 619 may use the new code and the new IE during negotiation messaging between the two devices. Using P2P as an example, the unauthorized users notification system may utilize P2P invitation response, provision discovery response and GO negotiation response frames to include the status code and the new IE to signal to a user a connection rejection. These frames may include additional information to assist the user in acquiring access to another device. For example, the IE may include contact information fields to assist the user in contacting the owner of the restricted device to request authorization.

The unauthorized users notification device 619 may include an IE in the probe response message to determine whether a device is authorized to connect to another device. For example, the IE may be defined as a “restricted device attribute” IE that may be included in a probe response message. This may allow a device to query a peer device on whether the device is authorized to connect to it, and to display this information in the device's GUI.

The unauthorized users notification device 619 may facilitate early signaling of access restriction resulting in power conservation during the discovery phase. That is, the unauthorized users notification system may allow a device to determine whether it is authorized to connect to another device even before the device attempts to connect. Information may be displayed to the user at the device's GUI. The information may be a grayed out list of devices, in case the device is unauthorized to access these devices. In another embodiment, the information may not be even presented to the unauthorized device.

It is understood that the above are only a subset of what the unauthorized users notification device 619 may be configured to perform and that other functions included throughout this disclosure may also be performed by the unauthorized users notification device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions. The device may further include instructions to at least one processor configured to access the at least one memory, wherein the at least one processor is configured to execute the computer-executable instructions to identify a request from a first device to establish a direct connection. The device may further include instructions to determine a connection status based at least in part on information included in the request. The device may further include instructions to generate a response frame including a connection status information element (IE). The device may further include instructions to cause to send the response frame to the first device.

The implementations may include one or more of the following features. The direct connection is a peer-to-peer connection. The connection status IE may include at least one of the connection status or information associated with a connection rejection. The request is at least one of a probe request, a group owner negotiation (GON) request, an invitation request, or a provision discovery request. The at least one processor may be further configured to execute the computer-executable instructions to identify information from the request. The device may further include instructions to determine the connection status based at least in part on the identified information. The identified information may include at least in part, an internet protocol (IP) address, a user name, a device ID, or a device location. The at least one processor may be further configured to execute the computer-executable instructions to cause to send to the first device a list of second devices. At least one of the second devices is marked as inaccessible by the first device based at least in part on the connection status. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include causing to send a request to establish a direct connection to a first device. The operations may include identifying a response, from the first device, to the request. The operations may include identifying at least one information element (IE) from the response. The operations may include determining a connection status based at least in part on the IE.

The IE may include at least in part information associated with a connection rejection. The request is at least one of a probe request, a group owner negotiation (GON) request, an invitation request, or a provision discovery request. The direct connection is a peer-to-peer (P2P) connection. The computer-executable instructions cause the processor to further perform operations comprising identifying a list of second devices belonging to a peer-to-peer (P2P) group. The operations may include displaying the list of the second devices on a graphical user interface (GUI). The operations may include determining an availability to connect with at least one of the second devices based at least in part on the displayed list.

According to example embodiments of the disclosure, there may include a method. The method may include identifying, by at least one processor, a request from a first device to establish a direct connection. The method may include determining, by the at least one processor, a connection status based at least in part on information included in the request. The method may include generating, by the at least one processor, a response frame including a connection status information element (IE). The method may include causing to send, by the at least one processor, the response frame to the first device.

The implementations may include one or more of the following features. The direct connection is a peer-to-peer connection. The connection status IE includes at least one of the connection status or information associated with a connection rejection. The request is at least one of a probe request, a group owner negotiation (GON) request, an invitation request, or a provision discovery request. The method may further include identifying, by the at least one processor, information from the request. The method may include determining, by the at least one processor, the connection status based at least in part on the identified information. The identified information includes at least in part, an internet protocol (IP) address, a user name, a device ID, or a device location. The method may further include causing to send, by the at least one processor, to the first device a list of second devices. At least one of the second devices is marked as inaccessible by the first device based at least in part on the connection status.

In example embodiments of the disclosure, there may be an apparatus. The apparatus may include means for identifying a request from a first device to establish a direct connection. The apparatus may include means for determining a connection status based at least in part on information included in the request. The apparatus may include means for generating a response frame including a connection status information element (IE). The apparatus may include means for causing to send the response frame to the first device.

The implementations may include one or more of the following features. The direct connection is a peer-to-peer connection. The connection status IE includes at least one of the connection status or information associated with a connection rejection. The request is at least one of a probe request, a group owner negotiation (GON) request, an invitation request, or a provision discovery request. The apparatus may further include means for identifying information from the request. The apparatus may include means for determining the connection status based at least in part on the identified information. The identified information includes at least in part, an internet protocol (IP) address, a user name, a device ID, or a device location. The apparatus may further include means for causing to send to the first device a list of second devices. At least one of the second devices is marked as inaccessible by the first device based at least in part on the connection status.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
identify a request from a first device to establish a direct connection;
determine a connection status based at least in part on information included in the request;
generate a response frame including a connection status information element (IE); and
cause to send the response frame to the first device.

2. The device of claim 1, wherein the direct connection is a peer-to-peer connection.

3. The device of claim 1, wherein the connection status IE includes at least one of the connection status or information associated with a connection rejection.

4. The device of claim 1, wherein the request is at least one of a probe request, a group owner negotiation (GON) request, an invitation request, or a provision discovery request.

5. The device of claim 1, wherein the at least one processor is further configured to execute the computer-executable instructions to:
identify information from the request; and
determine the connection status based at least in part on the identified information.

6. The device of claim 5, wherein the identified information includes at least in part an internet protocol (IP) address, a user name, a device ID, or a device location.

7. The device of claim 1, wherein the at least one processor is further configured to execute the computer-executable instructions to cause to send to the first device a list of second devices.

8. The device of claim 7, wherein at least one of the second devices is marked as inaccessible by the first device based at least in part on the connection status.

9. The device of claim 1, further comprising a transceiver configured to transmit and receive wireless signals.

10. The device of claim 9, further comprising one or more antennas coupled to the transceiver.

11. A non-transitory computer-readable medium storing computer-executable instructions which when executed by one or more processors result in performing operations comprising:
causing to send a request to establish a direct connection to a first device;
identifying a response, from the first device, to the request;
identifying at least one information element (IE) from the response; and
determining a connection status based at least in part on the IE.

12. The non-transitory computer-readable medium of claim 11, wherein the IE includes at least in part information associated with a connection rejection.

13. The non-transitory computer-readable medium of claim 11, wherein the request is at least one of a probe request, a group owner negotiation (GON) request, an invitation request, or a provision discovery request.

14. The non-transitory computer-readable medium of claim 13, wherein the direct connection is a peer-to-peer (P2P) connection.

15. The non-transitory computer-readable medium of claim 11, wherein the computer-executable instructions cause the processor to further perform operations comprising:
identifying a list of second devices belonging to a peer-to-peer (P2P) group;
displaying the list of the second devices on a graphical user interface (GUI); and
determining an availability to connect with at least one of the second devices based at least in part on the displayed list.

16. A method comprising:
identifying, by at least one processor, a request from a first device to establish a direct connection;
determining, by the at least one processor, a connection status based at least in part on information included in the request;
generating, by the at least one processor, a response frame including a connection status information element (IE); and
causing to send, by the at least one processor, the response frame to the first device.

17. The method of claim 16, wherein the direct connection is a peer-to-peer connection.

18. The method of claim 16, wherein the connection status IE includes at least one of the connection status or information associated with a connection rejection.

19. The method of claim 16, wherein the request is at least one of a probe request, a group owner negotiation (GON) request, an invitation request, or a provision discovery request.

20. The method of claim 16, further including:
identifying, by the at least one processor, information from the request; and
determining, by the at least one processor, the connection status based at least in part on the identified information.
